(19) United States
(12) Patent Application Publication
(10) Pub. No.: US 2018/0132477 A1
(43) Pub. Date: May 17, 2018

(54) Transportable Observation Station

(71) Applicant: ADC Custom Products, LLC, Weston, WI (US)

(72) Inventors: Joseph C. Yelle, Merrill, WI (US); Steve Deringer, Ringle, WI (US); Cyndi Schneider, Wausau, WI (US); Alexander Niemi, Schofield, WI (US); Andrew Howe, Wausau, WI (US); Kevin Juedes, Wausau, WI (US); Jeremy Wierzba, Rosholt, WI (US)

(73) Assignee: ADC Custom Products, LLC, Weston, WI (US)

(21) Appl. No.: 15/353,699

(22) Filed: Nov. 16, 2016

(51) Int. Cl. A01M 31/02; B60P 3/07; B66F 11/04

(52) U.S. Cl. CPC A01M 31/02; B60P 3/07; B60P 1/43; B66F 11/046; B66F 11/044

(57) ABSTRACT

Disclosed herein is a transportable observation station, having: a base; an observation platform; at least one jointed arm, having a first end and a second end, said jointed arm having: one or more extending joints for flexing and extending the jointed arm; one or more raising joints, operatively coupled to the base and the first end of the at least one jointed arm, for raising and lowering the at least one jointed arm; and a first controller module, mounted on the observation platform for controlling the raising, lowering, flexing and extending of the jointed arm; wherein the observation platform is operatively coupled to the second end of the jointed arm by a coupling, configured so that the observation platform remains substantially parallel to the base while the jointed arm is being raised, lowered flexed, or extended.

### FIELD OF THE INVENTION

The present application for patent relates to observation stations, and more particularly, pertains to a new, transportable observation and hunting station that can be moved into position, set up easily, and configured to accommodate physically able and differently abled users.

### BACKGROUND

The use of hunting stands is known in the art. More specifically, deer stands heretofore devised and utilized are known to consist basically of familiar, expected and obvious structural configurations, notwithstanding the myriad of designs encompassed by the crowded prior art which have been developed for the fulfillment of countless objectives and requirements.

Known hunting stands include U.S. Pat. No. 5,090,506; U.S. Pat. No. 5,101,934; U.S. Pat. Des. No. 306,348; U.S. Pat. No. 4,995,475; U.S. Pat. No. 4,579,198; U.S. Pat. No. 4,997,063, and U.S. Pat. No. 6,523,641.

In U. S. Pat. No. 6,523,641, Smith discloses a trailer-mounted, retractable elevated hunting stand, having a main shaft of a telescopic configuration that uses a gear and lead screw arrangement. The main shaft is proximally attached to a trailer, and telescopes into a bore in a second shaft, which acts as a brace, attached on the opposite end of the trailer. The main shaft is cranked into place, upward or downward; wherein the cranking motion rotates a bevel gear. The second shaft is similarly urged into place, typically using a crank and second bevel gear arrangement. The two telescoping shafts are connected, typically by a nut and lead screw. Once raised, the shooting platform, heretofore rotated out of position for transport, is rotated into position and locked to accommodate the person using the hunting stand. The shooting platform is braced to prevent tilting when in use, and affixed to a ladder, which may be a rope ladder or a chain ladder, to allow the user to climb into position. The hunting stand may also be adapted to carry an all terrain vehicle (ATV) or similar lightweight transportation device.

While the apparatus described in the Smith document, supra, provides a hunting stand that can carry an ATV, its operation requires considerable setup by an able bodied user, who then must climb into the shooting stand using a ladder. Such a device would not be suitable for use by one or more people; some of whom may be less than able bodied. Therefore, there remains a need for an easy-to-set up, transportable observation platform that may be used for hunting, or monitoring of woodland and other events, by able bodied and differently abled people such as those in wheelchairs. Such needs are addressed by the apparatus disclosed herein.

### BRIEF DESCRIPTION OF THE DRAWINGS

FIG. 1 illustrates the observation station disclosed herein in its folded configuration FIG. 1(a), its partially raised configuration FIG. 1(b), and its fully raised configuration FIG. 1(c).

FIG. 2 illustrates the observation station disclosed herein in its raised configuration, where outriggers are included for stability.

FIG. 3 illustrates a portion of the observation station disclosed herein, showing a jointed arm, a portion of the viewing platform and a portion of the safety railing.

FIG. 4 illustrates another portion of the observation station disclosed herein with its protective cover removed, showing the viewing platform, and ramp tracks for loading the ATV onto the trailer.

FIG. 5 illustrates the observation station disclosed herein, wherein the protective cover is on the top surface, and wherein and ATV has been parked in the top surface. FIG. 5(a) shows a rotated view and FIG. 5(b) shows a side view with the ramp tracks deployed.

FIG. 6 illustrates the observation station disclosed herein in its raised configuration, where extenders are included for lengthening the jointed arm.

### DETAILED DESCRIPTION OF THE DRAWINGS

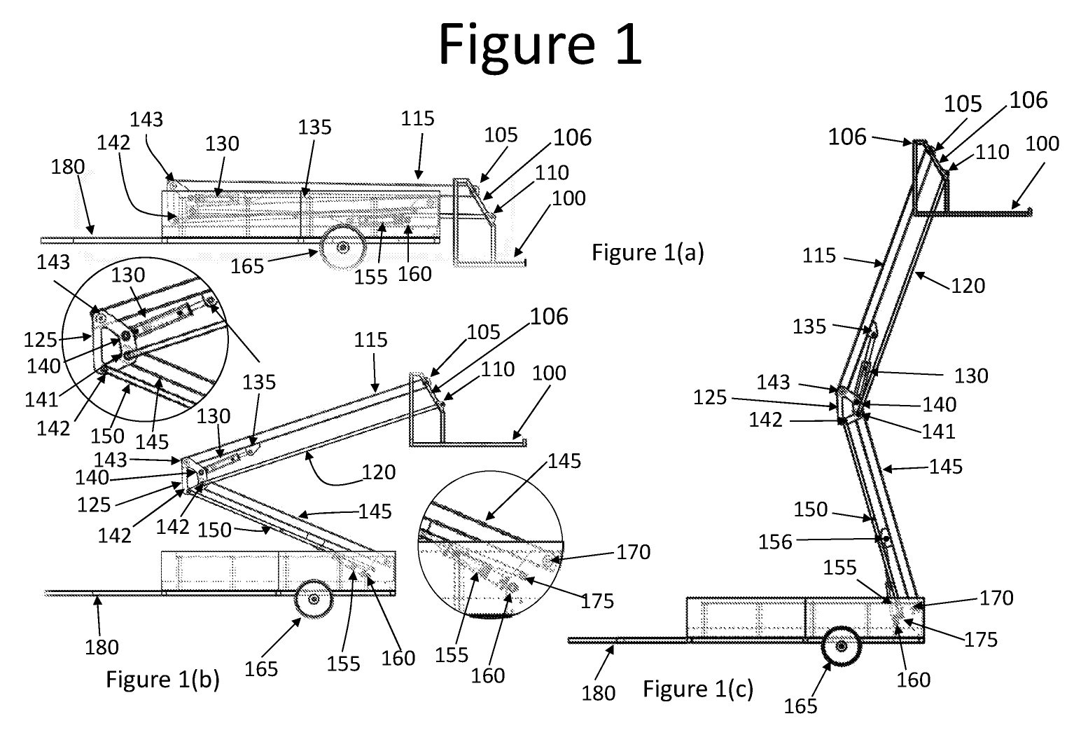

FIG. 1 illustrates the observation station disclosed herein in its folded configuration FIG. 1(a), its partially raised configuration FIG. 1(b), and its fully raised configuration FIG. 1(c). The platform, 100, is linked to the outer portion of the uppermost arm segment 115, via a superstructure, 106, at bushing 105 and to the inner portion of the uppermost arm segment 120, at bushing 110. Bushing 135 is mounted on the outer portion of the upper arm 115 and linked to the shaft of a hydraulic cylinder 130, whose body is mounted to elbow portion 125 at bushing 140. Elbow portion 125 is linked to the outer portion of the uppermost arm segment 115 at bushing 143. Elbow portion 125 is further linked to the inner portion of the uppermost arm segment 120, and the inner portion of the lowermost arm segment 145 at bushing 141, and the outer portion of the lowermost arm segment 150 at bushing 142. The outer portion of the lowermost arm segment segment 150 is further linked to the base 101 at bushing 175 and the base 101 is linked at bushing 160 to the body of hydraulic cylinder 155. The shaft of hydraulic cylinder 155 is linked to the inner portion of the lowermost arm segment 145 at bushing 156. The inner portion of the lowermost arm segment 145 is linked to the base 101 at bushing 170. Also shown is one of the wheels 165 and the towing beam 180.

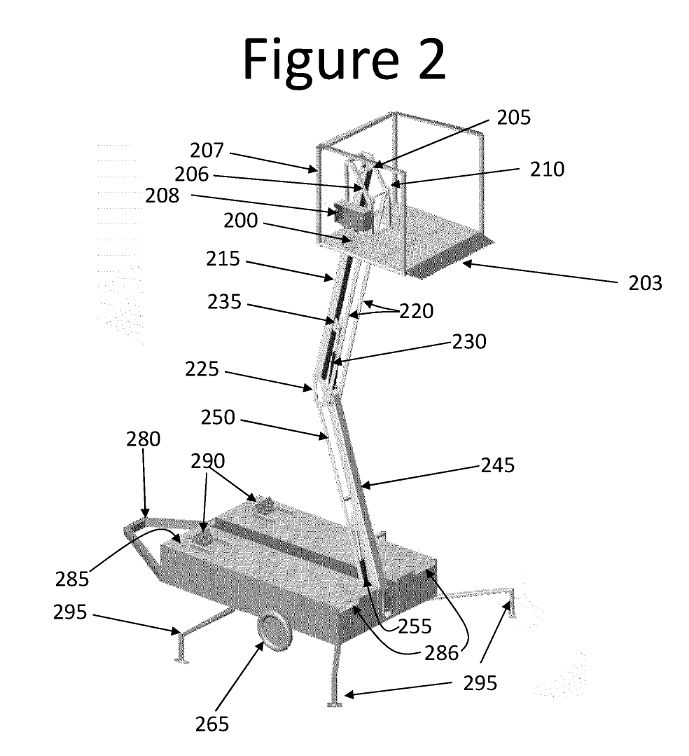

FIG. 2 illustrates the observation station disclosed herein in its raised configuration, where outriggers are included for stability. The platform, 200, is linked to the outer portion of the uppermost arm segment 215, via a superstructure, 206, at bushing(s) 205 and to the inner portion of the uppermost arm segment 220, shown in FIG. 2 as two parallel beams, at bushing(s) 210. Bushing 235 is mounted on the outer portion of the upper arm 215 and linked to the shaft of a hydraulic cylinder 230, whose body is mounted to elbow portion 225 via bushing(s) (not shown). Elbow portion 225 is linked to the outer portion of the uppermost arm segment 215 via bushing(s) (not shown). Elbow portion 225 is further linked to the inner portion of the uppermost arm segment 220, and the inner portion of the lowermost arm segment 245 via common bushings (not shown), and the outer portion of the lowermost arm segment 250 via bushing (not shown). The outer portion of the lowermost arm segment 250 is further linked to the base 201 via bushing(s) (not shown), and the base 201 is linked via bushing(s) (not shown) to the body of hydraulic cylinder 255. The shaft of hydraulic cylinder 255 is linked to the inner portion of the lowermost arm segment via bushing(s) not shown. The inner portion of the lowermost arm segment 245 is linked to the base 201 via bushing(s) (not shown). Also shown is one of the wheels 265, the towing beam 280, the platform cage 207, an instrument console (208), chock blocks 290 to accommodate an ATV or other light vehicle (the carried vehicle), a cover 285 to present a flat surface to the wheels of the carried vehicle. Stowed ramp tracks 286 facilitate loading of the carried vehicle, and outriggers, 295, provide stability to the platform it its various stages of operation. A platform ramp 203 may provide access by wheelchairs or other devices used by differently abled people.

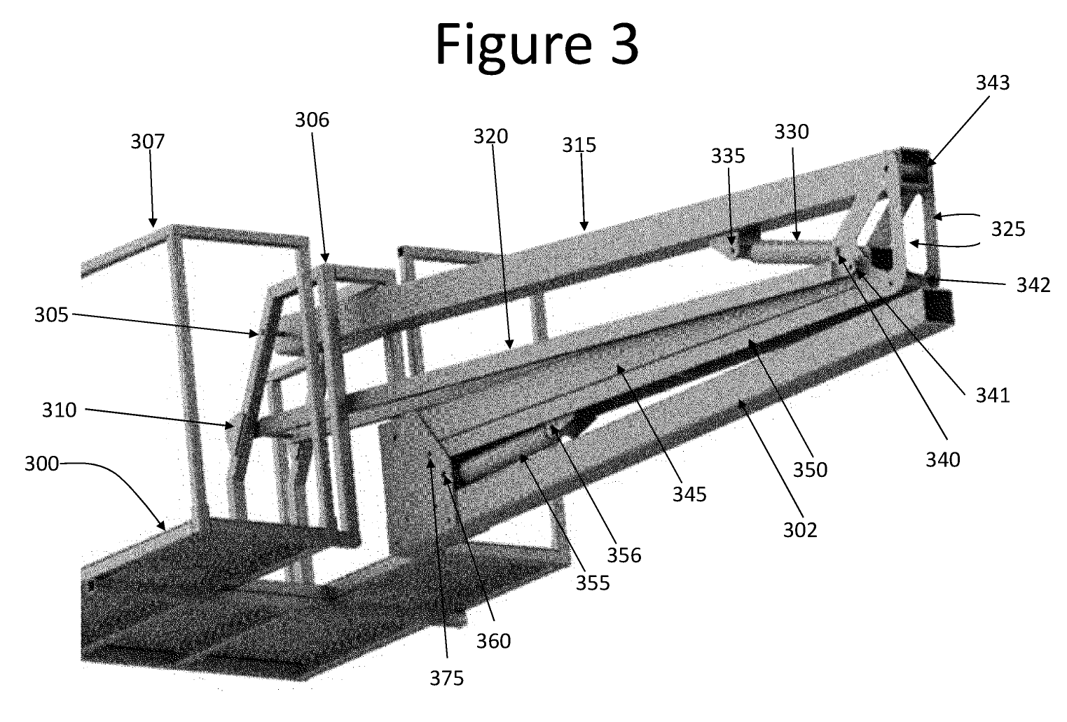

FIG. 3 illustrates a portion of the observation station disclosed herein, showing an embodiment of a jointed arm, a portion of the viewing platform and a portion of the safety railing. The platform, 300, is linked to the outer portion of the uppermost arm segment 315, via a superstructure, 306, at bushing 305 and to the inner portion of the uppermost arm segment 320, at bushing 310. Bushing 335 is mounted on the outer portion of the upper arm 315 and linked to the shaft of a hydraulic cylinder 330, whose body is mounted to elbow portion 325 at bushing 340. Elbow portion 325 is linked to the outer portion of the uppermost arm segment 315 at bushing 343. Elbow portion 325 is further linked to the inner portion of the uppermost arm segment 320, and the inner portion of the lowermost arm segment 345 at bushing 341, and the outer portion of the lowermost arm segment 350 at bushing 342. The outer portion of the lowermost arm segment 350 is further linked to the base 301 at bushing 375 and the base support beam 302 is linked at bushing 360 to the body of hydraulic cylinder 355. The shaft of hydraulic cylinder 355 (shaft hidden from view) is linked to the inner portion of the lowermost arm segment 345 at bushing 356. The inner portion of the lowermost arm segment 345 is linked to the base support beam 302. Also shown is the platform cage 307, and the superstructure 306.

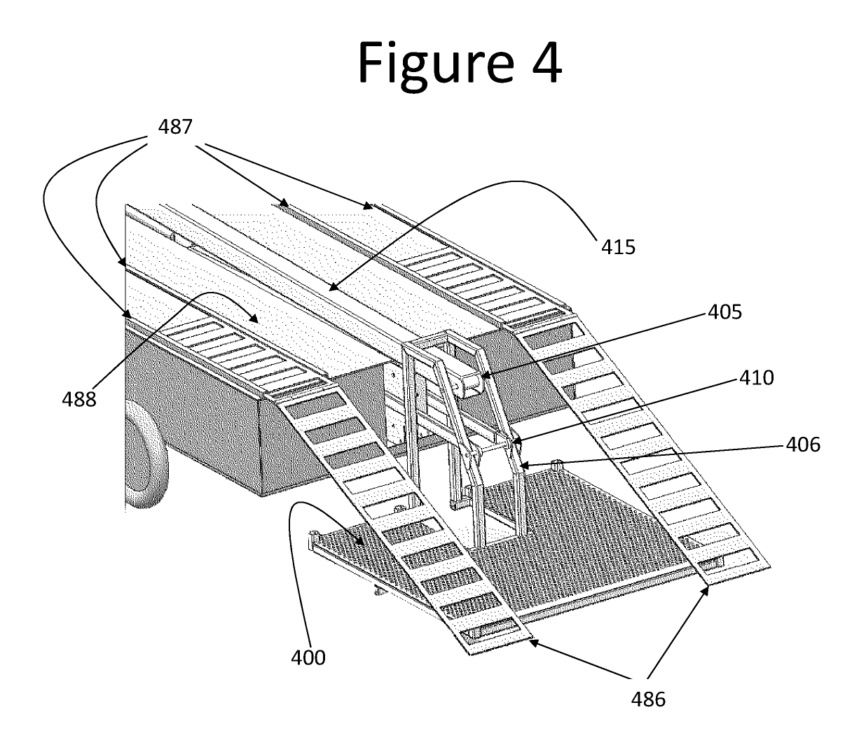

FIG. 4 illustrates another portion of the observation station disclosed herein with its protective cover removed, showing the viewing platform, and ramp tracks for loading an ATV onto the trailer. The ramp tracks 486 are shown deployed to allow the ATV to be mounted and demounted onto the trailer. While in transit, the ramp tracks are stowed using fixtures 487. Also shown are the platform with the platform cage removed 400, the superstructure 406, the linkage bushing 410 to the inner portion of the uppermost arm segment, the linkage bushing 405 to the outer portion of the uppermost arm segment, the outer portion of the uppermost arm segment, 415, and the subsurface of the trailer assembly 488.

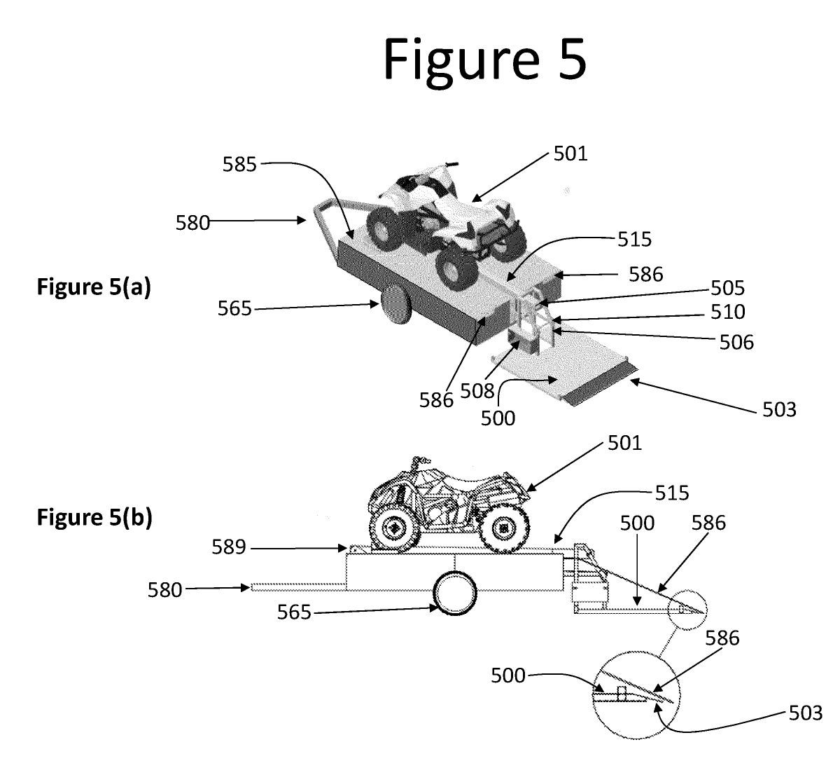

FIG. 5 illustrates the observation station disclosed herein, wherein the protective cover is on the top surface, and wherein and ATV has been parked in the top surface. FIG. 5(a) shows a rotated view and FIG. 5(b) shows a side view with the ramp tracks deployed. FIG. 5(a) shows the ramp tracks 586 stowed for travel after an ATV 501 has been parked on the surface 585 of the trailer. Also shown are the platform 500, the instrument module 508, the superstructure 506, the linkage bushing 510 to the inner portion of the uppermost arm segment, the linkage bushing 505 to the outer portion of the uppermost arm segment, the outer portion of the uppermost arm segment 515, the towing beam 580, and one of the wheels, 565. FIG. 5(b) shows the ramp tracks 586 deployed to allow an ATV or other light vehicle, the outer portion of the uppermost arm segment 515, the towing beam 580, chock blocks 589, and one of the wheels, 565. Also shown in both FIG. 5(a) and FIG. 5(b), a platform ramp 503 may provide access by wheelchairs or other devices used by differently abled people.

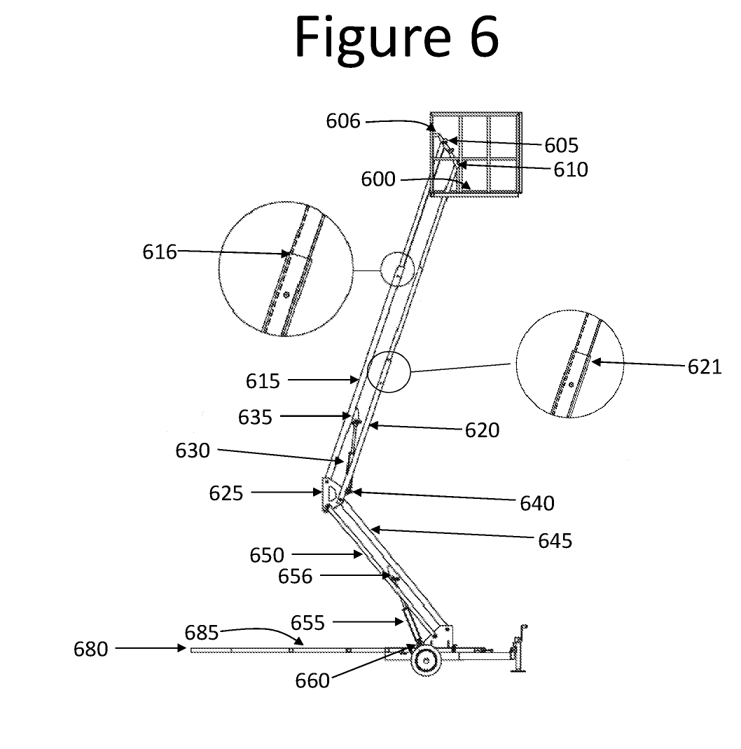

FIG. 6 illustrates the observation station disclosed herein in its raised configuration. The trailer sidewalls are removed to better illustrate the hardware. Extenders are included for lengthening the jointed arm. The platform, 600, is linked to the outer portion of the uppermost arm segment 615, via a superstructure, 606, at bushing(s) 605 and to the inner portion of the uppermost arm segment 620 at bushing(s) 610. Bushing 635 is mounted on the outer portion of the upper arm 615 and linked to the shaft of a hydraulic cylinder 630, whose body is mounted to elbow portion 625 via bushing(s) (not shown). Elbow portion 625 is linked to the outer portion of the uppermost arm segment 615 via bushing(s) (not shown). Elbow portion 625 is further linked to the inner portion of the uppermost arm segment 620, and the inner portion of the lowermost arm segment 645 via common bushings (not shown), and the outer portion of the lowermost arm segment 650 via bushing (not shown). The outer portion of the lowermost arm segment 650 is further linked to the base via bushing 660, and the base is linked via bushing(s) (not shown) to the body of hydraulic cylinder 655. The shaft of hydraulic cylinder 655 is linked to the inner portion of the lowermost arm segment via bushing 656. The inner portion of the lowermost arm segment 645 is linked to the base 601 via bushing(s) 660. Also shown are telescoping extenders 616 and 621 that move in concert to lengthen the jointed arm.

### DETAILED DESCRIPTION

As used herein, the conjunction “and” is intended to be inclusive and the conjunction “or” is not intended to be exclusive unless otherwise indicated or required by context. For example, the phrase “or, alternatively” is intended to be exclusive. For example, in the phrase, “a device that uses A or B,” an inclusive “or” is intended, indicating that the device may use A, B, or, both A and B.

As used herein, the term “bushing” refers to a device that allows rotating motion between a plurality of components. As used herein, the words “coupled” or “linked” may be understood to be interchangeable. As used herein, the term “exemplary” is used to indicate an example and is not intended to indicate preference.

### DESCRIPTION OF THE VARIOUS EMBODIMENTS

Disclosed herein is a transportable observation station, having: a base; an observation platform; at least one jointed arm, having a first end and a second end, said jointed arm having: one or more extending joints for flexing and extending the jointed arm; one or more raising joints, operatively coupled to the base and the first end of the at least one jointed arm, for raising and lowering the at least one jointed arm; and a first controller module, mounted on the observation platform for controlling the raising, lowering, flexing and extending of the jointed arm; wherein the observation platform is operatively coupled to the second end of the jointed arm by a coupling, configured so that the observation platform remains substantially parallel to the base while the jointed arm is being raised, lowered flexed, or extended.

Further disclosed herein is a transportable observation station, described in this section, further comprising extenders for lengthening the jointed arm.

Further disclosed herein is a transportable observation station, described in this section, further comprising outrigger structures on the base, for stabilizing the base when in use.

Further disclosed herein is a transportable observation station, described in this section, comprising a second controller module mounted on the base.

Further disclosed herein is a transportable observation station, described in this section, wherein the jointed arm folds at least partially into the base.

Further disclosed herein is a transportable observation station, described in this section, wherein the at least one jointed arm further comprises two or more extending joints.

Further disclosed herein is a transportable observation station, described in this section, wherein the at least one jointed arm is disposed between the base and the observation platform.

Further disclosed herein is a transportable observation station, described in this section, comprising two jointed arms, each having a first end and a second end, and each comprising: one or more extending joints for flexing and extending the jointed arms; and two raising joints, each operatively coupled to the base and the first ends of each jointed arm.

Further disclosed herein is a transportable observation station, described in this section, wherein the one or more extending joints or the one or more raising joints comprise a hydraulic cylinder chosen from a single action hydraulic cylinder, a double action hydraulic cylinder, a telescoping hydraulic cylinder, a plunger hydraulic cylinder, or a differential hydraulic cylinder, to urge the joint into its desired angle.

Further disclosed herein is a transportable observation station, described in this section, wherein the hydraulic cylinder is a position sensing hydraulic cylinder.

Further disclosed herein is a transportable observation station, described in this section, wherein the hydraulic cylinder comprises a viscous fluid, a thixotropic fluid, or a rheopectic fluid.

Further disclosed herein is a transportable observation station, described in this section, wherein the one or more extending joints or the one or more raising joints comprise a leveraging mechanism chosen from a winch, a ratchet lever, a pull jack, a ratchet cable, a pulley arrangement, a gear drive, a worm drive, a ball screw, a hydraulically driven piston, a pneumatically driven piston or combinations thereof, to urge the joint into its desired angle.

Further disclosed herein is a transportable observation station, described in this section, further comprising two or more wheels, operatively attached to the base.

Further disclosed herein is a transportable observation station, described in this section, further comprising means for slow emergency decent in the event of failure of the jointed arm.

Further disclosed herein is a transportable observation station, described in this section, further comprising means for loading and offloading a light vehicle.

The transportable observation station comprises a base, which may be configured with wheels so that it can be towed similarly to any conventional trailer.

### DETAILED DESCRIPTION

The base can be constructed of any suitable material, including, without limitation, metals, metal alloys, and metal carbides and oxides such as steel, aluminum, and titanium and alloys thereof, plastics, including fluorinated polymers, acrylic polymers, styrenic polymers, polyesters, polyamides, polyacrylonitrile, copolymers such as acrylonitrile butadiene styrene (ABS), carbon fiber, graphite, carbon nanotube or fiberglass reinforced resins, Vespel, Frelon, Nylon, MDS-filled nylon blends, PEEK (polyether-ether-ketone) blends, Polyacetals, poly tetrafluoroethylene (PTFE) such as Rulon (Saint-Gobain Performance Plastics) Glass-filled PTFE and the like and combinations of such materials. The base can further be coated with paints, rubberized coatings, powder coatings oxides, nitrides and the like. Compatible materials such as steel for use in pins, hinges and threaded rod may also be used.

The jointed arm may be mounted to the base using a hinged or bushing-type mount, or any other mount that permits rotation, hereinafter referred to as the base joint. By analogy to a biological arm, the jointed arm may be raised and lowered by rotating the arm into position at the base joint. By further analogy to a biological arm, the jointed arm may comprise an “elbow” joint that allows the arm to be extended or flexed to further raise the arm into position or to work cooperatively with the lower joint to lower the arm for transport. Rotation at any joint may be accomplished using hinges, bushings or other fixtures that permit rotation. Hinges and bushings may be made of any suitable material, such as steel, aluminum, and titanium and alloys thereof, plastics, including fluorinated polymers, acrylic polymers, styrenic polymers, polyesters, polyamides, polyacrylonitrile, copolymers such as acrylonitrile butadiene styrene (ABS), carbon fiber, graphite, carbon nanotube or fiberglass reinforced resins, Vespel, Frelon, Nylon, MDS-filled nylon blends, PEEK (polyether-ether-ketone) blends, Polyacetals, poly tetrafluoroethylene (PTFE) such as Rulon (Saint-Gobain Performance Plastics) Glass-filled PTFE and the like and combinations of such materials. In addition, joint assemblies may also comprise rubber or other elastomers to reduce vibration in the arm or on the platform. The jointed arm may be folded into a slot in the base to give clearance to the lightweight vehicle being transported on the base or it can fold on the surface of the base.

The arm components may have any suitable cross section, including circular, V-beam, I-beam, rectangular or the like. The components may be hollow, telescoping or solid.

In another embodiment, the arm may comprise a base joint and a hydraulic shaft, in place of, or in addition to, an elbow joint that raises the platform to the desired height once or as the base joint is rotated into place. The hydraulic shaft may include a hydraulic cylinder such as, but not limited to a single action hydraulic cylinder, a double action hydraulic cylinder, a telescoping hydraulic cylinder, a plunger hydraulic cylinder, or a differential hydraulic cylinder, to urge the arm into its desired height.

The observation platform may have length and width dimensions of from 2 feet by 2 feet to 12 feet by 12 feet. Within that range, an exemplary dimension range may be about 3 feet by about 3 feet to about 10 feet by about 10 feet. Moreover, the width and length of the observation platform may be rectangular. Accordingly, the platform may have dimensions of about 3 feet by about 4 feet to about 8 feet by about 10 feet. When in use, the observation platform may be raised off the ground from about 1 foot to about 30 feet. Within that range, an exemplary range may be about 5 feet to about 20 feet.

The controller may be fully manual or controlled electronically. Manual controls may provide electrical or mechanical engagement such that the arm is raised, lowered, extended or flexed in such a way as to raise or lower the platform. Simple manual controls may include switches, capacitive devices or other ways of achieving electrical engagement. In addition, the controller may comprise a logic circuit or a computing device such as a processor, operatively coupled to the controls as well as to sensors, actuators and the like. Actuators, may be employed to engage automatically to control motion. A second controller module may be mounted on the base or roughly at base level.

Processors may comprise any circuit for performing data processing, including digital signal processors, single processors, parallel processors, analog processors, memory management processors, optical processors, equivalents thereof and combinations thereof. In addition, processors may include auxiliary circuits, either integrated with the processor or in separate devices operating with the processor. Auxiliary circuits may be any circuit that provides an additional function on behalf of the processors and can be shared between two or more processors. Auxiliary circuits may include memories such as semiconductor memories, magnetoresistive memories, disk memories, flash memories, or any equivalent means for storing data. Auxiliary circuits and logic devices may comprise gate arrays, adders, other programmed logic circuits, amplifiers, triggers, A/D converters, D/A converters, optical interfaces, serial and parallel interfaces, buffers, masking circuits, encryption circuits, direct memory access circuits, equivalents thereof or combinations thereof.

Program logic may comprise computer programs written in any known language, such as C, C++, Pearl, Fortran, Basic, Pascal, assembly language, machine language, equivalents thereof or combinations thereof. Program logic may further comprise parallel processing logic for employing multiple processors or processor cores, direct memory access logic for continual monitoring functionality, masked direct memory access, interrupt routines, interrupt service routines, equivalents thereof or combinations thereof.

Table lookup logic may comprise interpolation and extrapolation routines, based on polynomials, spline functions, rational functions, normalized spectral elements, equivalents thereof or combinations thereof. Further, table lookup logic may comprise ordered table searching, searching with correlated values, estimation by neural networks, multidimensional estimation, equivalents thereof or combinations thereof. Data for table lookup may be obtained experimentally. Further, data be obtained by simulation that incorporates the mechanics of the platform assembly.

The processor may gather data using various sensors and other devices, such as pressure sensors, angle sensors, accelerometers, actuators and the like. By monitoring the various inputs, the platform may be raised or lowered comfortably without undo jerking, vibration, or tilting.

Pressure sensors may comprise piezoelectric sensors, piezoresistive sensors, capacitive sensors, which may comprise foams or other elastic materials as well as ceramics and fluids, electromagnetic sensors, in which the physical displacement of a diaphragm or cantilever causes changes in inductance, reluctance or capacitance, a linear variable differential transformer device, Hall effect devices, equivalents thereof or combinations thereof.

Angle sensors may comprise accelerometers, liquid capacitive inclinometers, electrolytic inclinometers, gas bubble in liquid devices, pendulum devices, giant magnetoresistive sensors, potentiometric sensors, Hall effect sensors, anisotropic magnetoresistive sensors, optical encoders, equivalents thereof or combinations thereof.

Accelerometers may comprise piezoresistive sensors, piezoelectric sensors, moving mass sensors, giant magnetoresistive sensors, anisotropic magnetoresistive sensors, capacitive sensors, resonant beam sensors, vibrating cantilever sensors, force balance sensors, transducer electronic data sheet (TEDS) accelerometers, wireless accelerometers, equivalents thereof or combinations thereof. Accelerometers may operate in uniaxial, biaxial or triaxial mode.

Actuators may comprise optoelectronic devices, CAM devices, linear motors, voice coils, moving magnetic actuators, amplified and direct piezoelectric devices, electric motors, pneumatic actuators, hydraulic pistons, relays, comb drive devices, thermal bimorphs, digital micromirror devices, electroactive polymers, screw jack, ball screw and roller screw actuators, hoist, winch, rack and pinion, chain drive, belt drive, rigid chain and rigid belt actuators, gear drive actuators, equivalents thereof or combinations thereof.

The sensors and actuators described above may be manufactured as microelectronic nanoelectronic or microelectromechanical devices, equivalents thereof or combinations thereof.

The controller module(s) may house the control apparatus or simply the switches necessary to operate them. The control apparatus may be mounted within the base or any other suitable position within the transportable observation station.

The transportable observation station may further comprise outrigger structures for stabilizing the base as the observation platform is being raised or lowered or held stationary at its desired height. As an example, the outrigger has a base end secured to the base and an angled or tilted orientation configured to contact the surface on which the base rests. The outrigger may be constructed of tubular material or of a material having another cross section such as rectangular, I-beam or V beam. Suitable materials for outriggers include steel, aluminum, alloys of the foregoing and structural plastics and reinforced plastic materials similar to those described hereinabove. The outrigger may further comprise a pad at the ground end to prevent pushing into the ground.

The observation platform need not have the superstructure on one end. The superstructure may reside in the center of the observation platform. Such an arrangement would, for example, enable the observation platform to be rotated on a turntable to allow the occupants to obtain a nearly 360° field of view.

The jointed arm may include two or more joints. Such an arrangement may allow the arm to be folded into a smaller compartment. Each joint is fitted with a way to raise or lower or flex or extend the joint as the case may be. Such ways of moving the joints may include hydraulic or other equivalent means. In such a configuration, the ‘raising or lowering joint would be coupled to the base of the transportable observation station and the extending joints would be disposed between the arm segments.

Urging the arm into its raised or lowered position may be accomplished by various leveraging mechanisms. These include winches, ratchet levers, jacks, ratchet cables, pulley arrangements, gear drives, worm drives, ball screws, hydraulically driven pistons, pneumatically driven pistons and combinations thereof, to urge the joint into its desired angle.

Winches can be driven by pneumatic motors, electric motors, fuel burning engines, hand operated cranks and the like. They may further include ratcheting mechanisms as well as capstans and hydraulic drivers.

Ratchets may comprise a round gear or linear rack with teeth, and a pivoting, spring-loaded finger called a pawl, that engages the teeth. The teeth are uniform but asymmetrical, with each tooth having a moderate slope on one edge and a much steeper slope on the other edge such as an asymmetrical saw tooth. In operation, the pawl allows motion in one direction but locks out motion in another direction. Free motion may be restored to the gear or linear rack by moving the pawl out of contact. However, it may be necessary to reverse the gear or linear rack so that the Pawl can be moved without encountering high frictional forces.

Jacks may be configured to pull a cord or cable or use a rod to pull or push the arm segments into position. Accordingly, a jack may operate as a pull jack or a prop jack. Jacks may be operated by hand, pneumatically, or hydraulically, and may be driven by electric, air driven, or fuel-powered motors.

Cable drive units include ratchet cables and pulley arrangements. These may be used alone or in combination with other types of drive apparatuses. In addition, such devices provide an inexpensive way to employ redundancy.

Other known leveraged drive mechanisms such as gear and worm drives may be employed alone or in combination with other mechanisms described herein. In gear drives, leverage is applied by applying a small gear to a larger gear of obtain a mechanical advantage. In a worm drive, leverage is obtained by applying a cylindrical screw to a circular gear to obtain a mechanical advantage. Gear and worm dives may be operated by hand, using a crank or other suitable driver, pneumatically, or hydraulically, and may be driven by electric, air driven, or fuel-powered motors.

Piston devices such as pneumatically driven pistons or hydraulically driven pistons may also be used. In certain configurations, piston drives may have the advantage of being able to drive and inhibit motion in both directions, allowing a relatively inexpensive method of controlling raising, lowering, flexing and extending the arm.

Ball screws provide mechanical linear motion by translating rotational motion to linear motion with little friction. A threaded shaft provides a helical raceway for ball bearings which act as a precision screw to urge the respective arm segments into the desired angle. Ball screws may be operated by hand, using a crank or other suitable driver, pneumatically, or hydraulically, and may be driven by electric, air driven, or fuel-powered motors, and may employ ratcheting devices to hold the arm segments in place.

Hydraulic cylinders provide a unidirectional force through a unidirectional stroke. A mechanical advantage may be obtained by urging an incompressible fluid into a cylinder of a given cross sectional area. The applied pressure moves a piston of a different cross sectional area; thus providing a force equal to the fluid pressure inside the cylinder times the effective area of the piston. Various kinds of hydraulic cylinders are known. For example, without limitation, the hydraulic cylinder may be a single action hydraulic cylinder, a double action hydraulic cylinder, a telescoping hydraulic cylinder, a plunger hydraulic cylinder, a differential hydraulic cylinder, or a position sensing “smart” hydraulic cylinder.

Single action hydraulic cylinders use fluid pressure on one side of a piston to generate force in one direction. Generally, gravity and the weight of the load being pushed or pulled creates movement in the opposing direction. Single acting piston cylinders sometimes incorporate a spring to urge motion in the opposing direction by compressing the spring during the forward stroke.

Double action hydraulic cylinders have the working fluid on both sides of the piston. The fluid may be pressurized on either side of the piston to urge motion toward one side or another. The difference in pressure between the two sides of the piston causes motion in the direction of the lower pressure. Managing the pressures on either side of the piston may allow avoidance of a “jerking” motion on the platform.

A telescoping hydraulic cylinder is usually a single acting hydraulic cylinder with a piston inside a telescoping barrel. It is sometimes used to provide a longer stroke in a short package.

In a plunger hydraulic cylinder the piston rod, called the plunger, acts as its own piston. In most cases, the plunger cylinder is fairly thick, relative to the outer diameter of the cylinder. Plunger-type-hydraulic cylinders usually act as single action devices.

A differential cylinder operates similarly to a normal cylinder when pulling. However, if the cylinder pushes, the oil from the piston rod side goes to the bottom side of the cylinder instead of to a reservoir. Accordingly, the cylinder rod goes much faster, but the maximum force the cylinder can supply closely resembles that from a plunger cylinder.

In a position sensing hydraulic cylinder, a hollow cylinder rod is not required. A permanent magnet is affixed to the inside of the piston, allowing a Hall-effect sensor to detect the position of the magnet, and, thereby, the piston by monitoring the magnetic field outside the cylinder, through the steel wall. Such devices may be useful in controlling the height of the platform or in detecting even minor errors or system failures.

Hydraulic fluids are sometimes selected for their viscosity. In the current application such a selection may be significant because the portable observation station is contemplated to be used in a rage of environmental conditions such as in summer heat and winter cold. Since the viscosity of a fluid varies with temperature, the fluid may be chosen to provide hydraulically driven motion without expending an undue amount of energy overcoming the viscous forces of the fluid at low temperatures or providing a “jerky” motion at warm temperatures because the fluid may be unacceptably thin. In addition, thin fluids may exhibit leakage past the piston surface.

In addition to temperature effects, hydraulic fluids can exhibit a variety of viscous flow characteristics. For example, the hydraulic fluid can be a Newtonian fluid, in which the viscous stresses arising from its flow at every point, are proportional to the local strain rate—the rate of change of deformation over time. Exemplary hydraulic fluids such as oils usually behave as Newtonian fluids.

In addition, non Newtonian fluids may be useful, particularly in situations where the hydraulic cylinder may begin to leak. Fluids that require a gradually increasing shear stress to maintain a constant strain rate are referred to as rheopectic. In such fluids, the apparent viscosity increases with duration of applied stress. Examples of rheopectic fluids include synovial fluid, printer ink, and suspensions of finely divided gypsum. An opposite case of this is a fluid that thins out with time and requires a decreasing stress to maintain a constant strain rate (thixotropic). In other words, the apparent viscosity decreases with duration of the applied stress. An example of a thixotropic fluid is hydrogenated castor oil.

As the platform is raised, it is held substantially level to the base. This enables the user(s) to “ride” the platform up to the desired height. This may be accomplished by maintaining that the outer portion of the uppermost arm segment 115, the inner portion of the uppermost arm segment 120, elbow portion 125, and super structure 106 form, and maintain the properties of, a parallelogram. This means opposite angles are substantially congruent and opposite sides are substantially congruent and substantially parallel. The lengths between bushings on superstructure 106 and elbow portion 125 are substantially equal, as well as the lengths of the outer portion of the uppermost arm segment 115 and inner portion of the uppermost arm segment 120. These four lengths form the parallelogram. The inherent geometry of a parallelogram ensures that the platform is in a position that is substantially level to the base.

Another configuration is to suspend the platform by a ball joint to allow constant leveling as the platform is raised into position or lowered. As another example, the degree of leveling of the platform may be controlled with the aid of accelerometers that provide feedback to a set of digitally driven motors that hold the platform level.

In still another embodiment hydraulic levelers may be used to keep the observation platform level as it is raised or lowered. Hydraulic levelers comprise a set of hydraulic jacks; each of which raises or lowers its respective point of contact in response to mechanical or electronic input from sensors. In one embodiment, the hydraulic leveling system responds to input from a controller, which, in turn receives data from one or more accelerometers, operatively coupled to the controller. Hydraulic leveling systems are commercially available. As an example, hydraulic levelers may be obtained from HWH Corporation of Moscow, Iowa.

The platform may be a flat surface as shown in FIG. 1, usually, with a protective cage mounted on the platform, as illustrated in FIG. 2, or it may, for example, be an enclosed bucket, configured with a door to permit simple ingress and egress. Further, the platform may be equipped with its own ramp to allow access by wheelchairs or similar devices.

In FIG. 6 is illustrated the portable observation station configured in such a way that the outer portion of the uppermost arm segment 115, and the inner portion of the uppermost arm segment 120 are telescoped so as to provide additional height to the observation platform. The platform may be kept substantially parallel to the base as long as the outer portion of the uppermost arm segment 115, is substantially parallel to the inner portion of the uppermost arm segment 120 and the ratio of their lengths is kept substantially constant.

For safety reasons, it may be desirable to employ means for slow emergency decent in the event of failure of the jointed arm. Such means may include check valves in the hydraulic cylinders that slowly release hydraulic fluid into the fluid reservoir of the hydraulic cylinder; thus slowing the decent of the observation platform. In addition, should a rapid decent begin to occur, springs and shock absorbers may be used to slow the observation platform before it hits the ground. Means for slow emergency decent could further include a redundant set of hydraulic cylinders or equivalents thereof. To save space, such a redundant set of hydraulic cylinders might also include telescoping hydraulic cylinders. Further means include slowing by magnetic induction, magnetic levitation or equivalents thereof. Further means for slow emergency decent, include springs configured at the joints, configured to oppose decent. Still further means for slow emergency decent include using viscous or non Newtonian hydraulic fluids that oppose flowing out of the cylinder in the event of a hydraulic fluid leak.

Means for loading or off loading the small vehicle onto the transportable observation station include ramps, use of a loading platform, a compact crane, a winch, along with oversized tires on the small vehicle, using the observation platform to lift the small vehicle onto the observation station trailer, and equivalents thereof.

Although the present invention has been shown and described with reference to particular examples, various changes and modifications which are obvious to persons skilled in the art to which the invention pertains are deemed to lie within the spirit, scope and contemplation of the subject matter set forth in the appended claims.

What is claimed is:

1. A transportable observation station, comprising:
a. a base;
b. an observation platform; and
c. a jointed arm, having a first end and a second end, comprising: one or more extending joints for flexing and extending the jointed arm;
d. one or more raising joints, operatively coupled to the base and the first end of the at least one jointed arm, for raising and lowering the at least one jointed arm; and
e. a first controller module, mounted on the observation platform for controlling the raising, lowering, flexing and extending of the jointed arm;
wherein the observation platform is operatively coupled to the second end of the jointed arm by a coupling, configured so that the observation platform remains substantially parallel to the base while the jointed arm is being raised, lowered flexed, or extended.

2. The transportable observation station of claim 1, further comprising extenders for lengthening the jointed arm.

3. The transportable observation station of claim 1, further comprising outrigger structures on the base, for stabilizing the base when in use.

4. The transportable observation station of claim 1, further comprising a second controller module, mounted on the base.

5. The transportable observation station of claim 1, wherein the jointed arm folds at least partially into the base.

6. The transportable observation station of claim 1, wherein the at least one jointed arm further comprises two or more extending joints.

7. The transportable observation station of claim 1, wherein the at least one jointed arm is disposed between the base and the observation platform.

8. The transportable observation station of claim 1, wherein the one or more extending joints or the one or more raising joints comprise a hydraulic cylinder chosen from a single action hydraulic cylinder, a double action hydraulic cylinder, a telescoping hydraulic cylinder, a plunger hydraulic cylinder, or a differential hydraulic cylinder, to urge the joint into its desired angle.

9. The transportable observation station of claim 8, wherein the hydraulic cylinder is a position sensing hydraulic cylinder.

10. The transportable observation platform of claim 8, wherein the hydraulic cylinder comprises a viscous fluid, a thixotropic fluid, or a rheopectic fluid.

11. The transportable observation station of claim 1, wherein the one or more extending joints or the one or more raising joints comprise a leveraging mechanism chosen from a winch, a ratchet lever, a pull jack, a ratchet cable, a pulley arrangement, a gear drive, a worm drive, a ball screw, a hydraulically driven piston, a pneumatically driven piston or combinations thereof, to urge the joint into its desired angle.

12. The transportable observation station of claim 1, further comprising two or more wheels, operatively attached to the base.

13. The transportable observation station of claim 1, further comprising means for slow emergency decent in the event of failure of the jointed arm.

14. The transportable observation station of claim 1, further comprising means for loading and offloading a light vehicle.

15. The transportable observation station of claim 1, further comprising a telescoping portion of the jointed arm to allow extension of the arm once it is raised and extended.

16. The transportable observation station of claim 1, further comprising a platform ramp, to allow ease of access by differently abled people.
